(19) United States
(12) Patent Application Publication
(10) Pub. No.: US 2010/0053575 A1
(43) Pub. Date: Mar. 4, 2010

(54) Thermal Control For EUV Lithography

(75) Inventors: I-Hsiung Huang, Hsinchu County (TW); Tsiao-Chen Wu, Jhudong Township (TW); Hsin-Chang Lee, Hsin-Pu Zhen (TW); Anthony Yen, Jhubei City (TW)

Correspondence Address: HAYNES AND BOONE, LLP;IP Section, 2323 Victory Avenue, Suite 700, Dallas, TX, 75219, US

(73) Assignee: TAIWAN SEMICONDUCTOR MANUFACTURING COMPANY, LTD., Hsin-Chu (TW)

(21) Appl. No.: 12/204,527

(22) Filed: Sep. 4, 2008

(51) Int. Cl. G03B 27/52

(52) U.S. Cl. 355/30

(57) ABSTRACT

A method of patterning an integrated circuit including generating a thermal profile of a reticle is provided. The thermal profile of the reticle may illustrate heat accumulation (e.g., a temperature) in a EUV reticle due an incident EUV radiation beam. The thermal profile may be determined using the pattern density of the reticle. The reticle is irradiated with a radiation beam having an extreme ultraviolet (EUV) wavelength. A thermal control profile may be generated using the thermal profile, which may define a parameter of the lithography process such as, a temperature gradient of a thermal control chuck. The thermal control profile may be downloaded to the EUV lithography tool (e.g., scanner or stepper) for use in a process. A separate thermal control profile may be provided for different reticles.

### BACKGROUND

The present disclosure is related to photolithography such as used in the fabrication of semiconductor devices, and more particularly the disclosure pertains to thermal control for extreme ultraviolet (EUV) lithography.

As integrated circuit performance requirements increase and size constraints decrease, the need to perform higher resolution lithography processes grows. One process being developed to provide a finer resolution is “extreme ultraviolet” (EUV) lithography, otherwise known as “soft x-ray.” EUV lithography uses radiation of an x-ray wavelength (e.g., 5-20 nm). In EUV lithography, a reflective reticle (e.g., mask) is used. The desired pattern is provided on an absorption layer formed on the reflective reticle. The reflective layer however does not fully reflect the incident radiation; a portion of the radiation is absorbed by the reticle. This results in the reticle being heated, which may cause issues with performing photolithography (e.g., resulting from distortion of the reticle). Therefore, what is desired is an understanding and/or improvement of the thermal conditions of a reticle, in particular, as used in EUV lithography.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 illustrates a schematic of an embodiment of a lithography system.

FIG. 2 illustrates a cross-sectional view of an embodiment of a reticle.

FIG. 3a illustrates a cross-sectional view of an embodiment of a lithography device including a reticle and reticle housing.

FIG. 3b illustrates a cross-sectional view of an embodiment of a thermal control chuck.

FIG. 4 illustrates cross-sectional views of embodiments of reticles at various stages of a lithography process.

FIG. 5 illustrates a flowchart of an embodiment of a method of providing a thermal control profile.

FIG. 6 illustrates a schematic of an embodiment of a layout of reticle.

FIGS. 7, 8, and 9 illustrate top views of embodiments of layouts of reticles including their pattern densities.

FIGS. 10, 11, and 12 illustrate embodiments of thermal profiles associated with the layouts of FIGS. 7, 8, and 9.

FIG. 13 illustrates a flowchart of an embodiment of a method of performing a lithography process.

FIG. 14 illustrates a block diagram of an embodiment of computer system 1400.

### DETAILED DESCRIPTION

It is understood that specific embodiments are provided herein as examples to teach the broader inventive concept, and one of ordinary skill in the art can easily apply the teaching of the present disclosure to other methods or systems. In addition, it is understood that the methods and systems discussed in the present disclosure include some conventional structures and/or processes. Since these structures and processes are well known in the art, they will only be discussed in a general level of detail. Reference numbers may be repeated throughout the drawings for sake of convenience and example, and such repetition does not indicate any required combination of features or steps throughout the drawings. Furthermore, though described herein as being applicable to semiconductor integrated circuit fabrication, one skilled in the art would recognize other design processes that may benefit from the disclosure, including, for example, fabrication of displays (e.g., TFT-LCD).

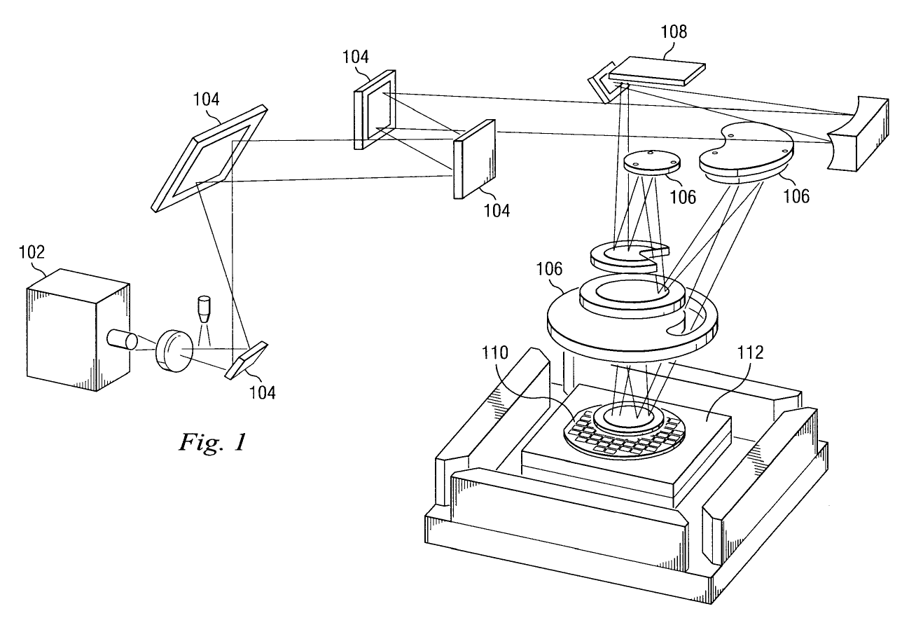

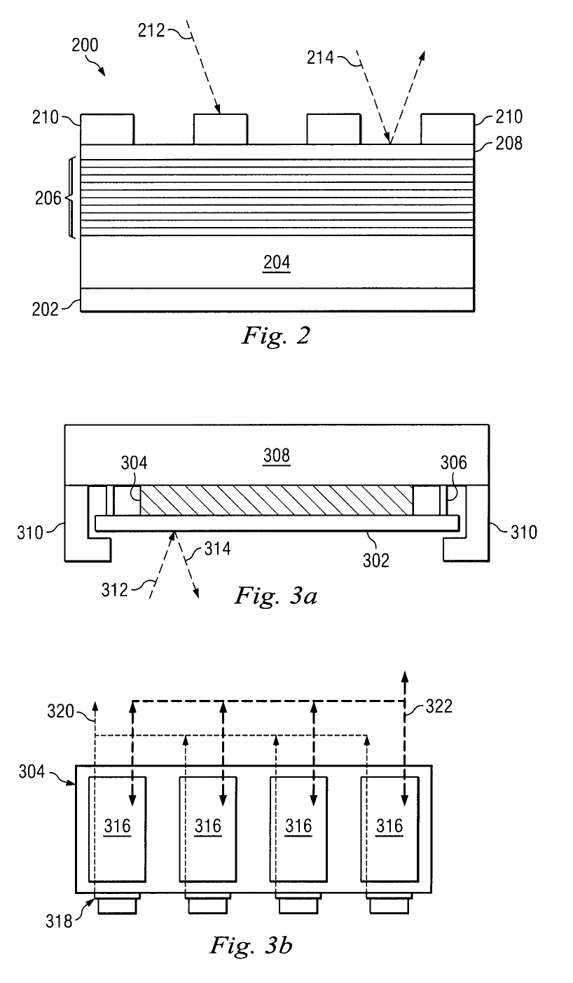

Referring to FIG. 1, a EUV lithography system 100 is illustrated. The EUV lithography system 100 may include a EUV scanner tool. The lithography system 100 includes a radiation source 102, a plurality of illumination optics 104, a plurality of projection optics 106, a reticle 108, a target substrate 110, and a substrate stage 112. However, other configurations and inclusion or omission of devices may be possible. The radiation source 102 includes a source providing electromagnetic radiation having a wavelength in the extreme ultraviolet (EUV) range. In an embodiment, the radiation source provides EUV radiation having a wavelength of approximately 13.5 nm. The illumination optics 104 are configured to guide a radiation beam to the reticle 108. The reticle 108 may be a reflective reticle (e.g., mask) such as described in further detail with reference to FIG. 2. The reticle 108 may be positioned on a reticle chuck, as described in further detail with reference to FIG. 3. The electromagnetic radiation reflected from the reticle (e.g., a patterned radiation beam) is collected by the projection optics 106. The projection optics 106 may be reflective and may include a magnification of less than one (thereby reducing the patterned image included in the radiation). The projection optics 106 direct the patterned radiation to the substrate 110 (e.g., a semiconductor wafer). The substrate 110 includes a photosensitive layer (e.g., photoresist or resist) sensitive to the EUV radiation. The substrate 110 is held by a substrate stage 112. The substrate stage 112 provides control of the substrate 110 position such that the image of the reticle 108 is scanned onto the substrate 110 in a repetitive fashion (though other lithography methods are possible). The lithography system 100 or portion thereof may include a vacuum atmosphere.

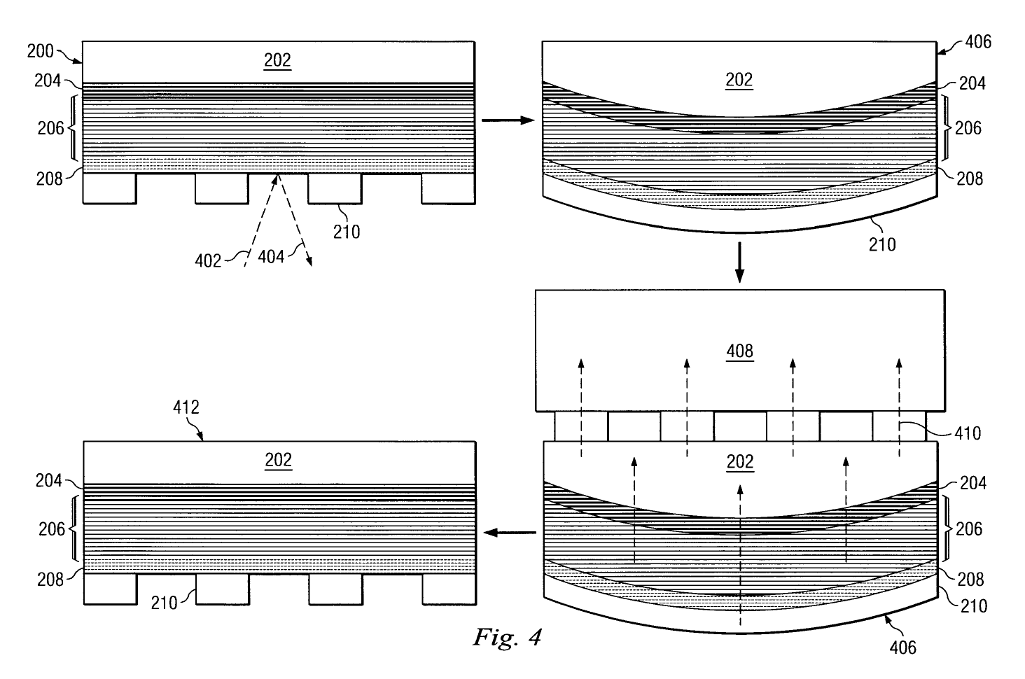

Using the EUV lithography system 100 as described above may provide for disadvantages. Heat may accumulate in the reticle 108 from absorption of incident radiation from the source 102. Heat absorption can cause issues such as distortion (e.g., warping) of the reticle 108, described in further detail below with reference to FIG. 4. Excessive distortion of the reticle 108 can cause issues in providing an accurate pattern in the beam, as well as providing an accurate pattern or plurality of pattern features on the substrate 110. To counter this heat accumulation, the reticle 108 may be placed on a thermal control chuck, which reduces the heat accumulation by thermal conduction as described in further detail herein, and/or various other thermal control methods may be employed.

Referring now to FIG. 2, illustrated is an embodiment of a reticle 200. The reticle 200 may be substantially similar to the reticle 108 described above. The reticle 200 is a reflective reticle. The reticle 200 includes a low thermal expansion (LTE) substrate 204. The LTE substrate 204 may include LTE glass, quartz, silicon, silicon carbide, black diamond, and/or other low thermal expansion substances known in the art. A multiple layer film 206 is formed on the substrate 204. The multiple layer film 206 provides reflectivity. The multiple layer film 206 may be selected such that it provides a high reflectivity to a selected radiation type/wavelength (e.g., reflectivity of 70%). In an embodiment, the multiple layer film 206 includes a plurality of layers of molybdenum (Mo) and silicon (Si). A typical number of layer-pairs is 40 (e.g., 40 layers each layer including a Mo and Si layer), however any number of layers is possible. A capping layer 208 (e.g., buffer layer) is formed on the multiple layer film 206. In an embodiment, the capping layer 208 includes ruthenium (Ru), though other compositions may be possible. In an embodiment, the capping layer 208 is approximately 2.5 nm thick. An absorption layer 210 is formed on the capping layer 208. The absorption layer 210 is a patterned layer including a pattern formed by the presence/absence of the absorption material; the pattern defines feature(s) to be imaged onto a substrate. In an embodiment, the absorption layer 210 includes low reflectivity tantalum boron nitride (LR—TaBN), though other compositions are possible. In an embodiment, the absorption layer 210 is approximately 70 nm in thickness. Formed on the opposing surface of the substrate 204 is the conductive layer 202. In an embodiment, the conductive layer includes chromium nitride (CrN), though other compositions are possible. The conductive layer 202 is operable to provide for coupling the reticle 200 to a reticle chuck electrostatically. Any one or more of the layers 202, 204, 206, 208, and 210 may be formed using methods such as, sputtering, electron beam deposition, plating, and/or other methods known in the art. The compositions and/or physical structures of one or more layers described above may be selected based upon reflectivity/absorption of the radiation to be used with the reticle 200, the stress compatibility with adjacent layers, and/or other criteria known in the art.

FIG. 2 also illustrates incident radiation 212 and 214. The incident radiation may be provided using a source (e.g., a EUV source) substantially similar to the source 102, described above with reference to FIG. 1. The incident radiation beam 212 illustrates absorption of the beam 212 by the reticle 200 including the absorption layer 212, the capping layer 208 and/or the multiple layer film 206. The radiation beam 214 illustrates a reflected beam. The reflected beam is a patterned beam, patterned according the pattern defined by the absorption layer 210.

Referring now to FIGS. 3a and 3b, illustrated is a EUV lithography apparatus 300. The lithography apparatus 300 includes a reticle and reticle housing. In particular, the lithography apparatus 300 includes a reflective reticle 302 and the reticle housing including a reticle chuck 304, a reticle stage 308, a plurality of needles 306, and support members 310. The lithography apparatus 300 may be included in the lithography system 100, described above with reference to FIG. 1. The reflective reticle 302 may be substantially similar to the reticle 108 and/or the reticle 200, described above with reference to FIGS. 1 and 2 respectively. The reticle chuck 304 may hold the reticle 302 electrostatically. To hold the reticle 302 electrostatically, a voltage may be applied to the needles 306, for example, while the chuck 304 is grounded. Other methods of mounting the reticle 302 to the chuck 304 may be possible such as by vacuum or mechanical mounting. The reticle 302 is mounted such than an absorption layer is facing downward (relative to FIG. 3). The support members 310 are operable to hold the reticle such that damage is prevented/reduced on detachment of the reticle 302 from the chuck 304. An incident radiation beam 312 is also illustrated. In an embodiment, the incident radiation beam 312 is directed to the reticle 302 at an approximately 6 degree angle. Radiation beam 314 illustrates the reflected, patterned, beam.

Referring now in particular to FIG. 3b, illustrated is the reticle chuck 304 in greater detail. The reticle chuck 304 may be a thermal control chuck (or temperature control chuck). The thermal control chuck may have multiple temperature zones that can provide thermal control according to a thermal control profile (e.g., provide an compensating temperature gradient across the chuck). The reticle chuck 304 includes a plurality of thermal couples 316 and a plurality of temperature sensors 318. Each which may correspond to a temperature zone and thus, provide a separately controllable zone of the thermal control chuck. The temperature sensors 318 are coupled to a sensor controller 320. The thermal couples 316 are coupled to a control loop mechanism (e.g., a PID controller). Thus, each of the plurality of temperature sensors 318 and thermal couples 316 may be independently controlled and/or monitored. The temperature sensor controller 320 can provide a thermal profile based on the EUV mask heating. The PID controller 322 may utilized this profile to compensate for such heating (as described below with reference to FIG. 4). The PID controller 322 may provide and implement a thermal control profile.

The chuck 304 includes a high thermal conductivity material. Examples of materials that may be included in the chuck 304 include Cr, CrN, Cu, Ag, Al, AlxOy, and/or other materials with high thermal conductivity. The chuck 304 may include a metal or alloy base to be used in the chuck 304, and/or a portion of the chuck 304. In an embodiment, a layer may be formed on the backside of the chuck 304 adjacent the reticle 302. The layer may include high thermal conductivity composition.

Referring now to FIG. 4, illustrated is the reticle 200 being exposed to EUV radiation. A radiation beam 402 is incident on the reticle 200 such as provided during an EUV lithography process. A portion of the radiation beam is reflected by the reticle 200 illustrated as reflected beam 404. However, a portion of the radiation beam 402 is absorbed by the reticle 200. When the reticle 200 absorbs the radiation, heat is generated in the reticle 200. The heat can cause distortion (e.g., warping) such as depicted in a reticle portion 406. In an embodiment, the reticle 200 accumulates heat by absorbing approximately 30-40% of the radiation energy incident the reticle (e.g., 30-40% radiation beam 402 is absorbed and 70-60% is reflected.) When heat accumulates in the reticle 200, distortion (e.g., warping) of the reticle 200 may occur providing distorted reticle 406 (illustrated as a portion of reticle 200).

Using a distorted reticle, such as distorted reticle 406, may cause issues in photolithography. With no mechanism to control the reticle shape or disclosure, the distorted reticle 406 may cause issues such as out of plane deviation (OPD) and in plane deviation (IPD). IPD includes distortion or mislocating a pattern feature on a substrate in directions within the reticle plane (e.g. horizontally on the surface of the substrate) or translation errors. This can cause overlay errors of pattern features on the substrate. OPD refers to distortion in a direction perpendicular to the plane of the reticle, which affects the focus of the lithography system. Further distortion may cause a shift of the exposure field such that it is no longer within the depth of focus.

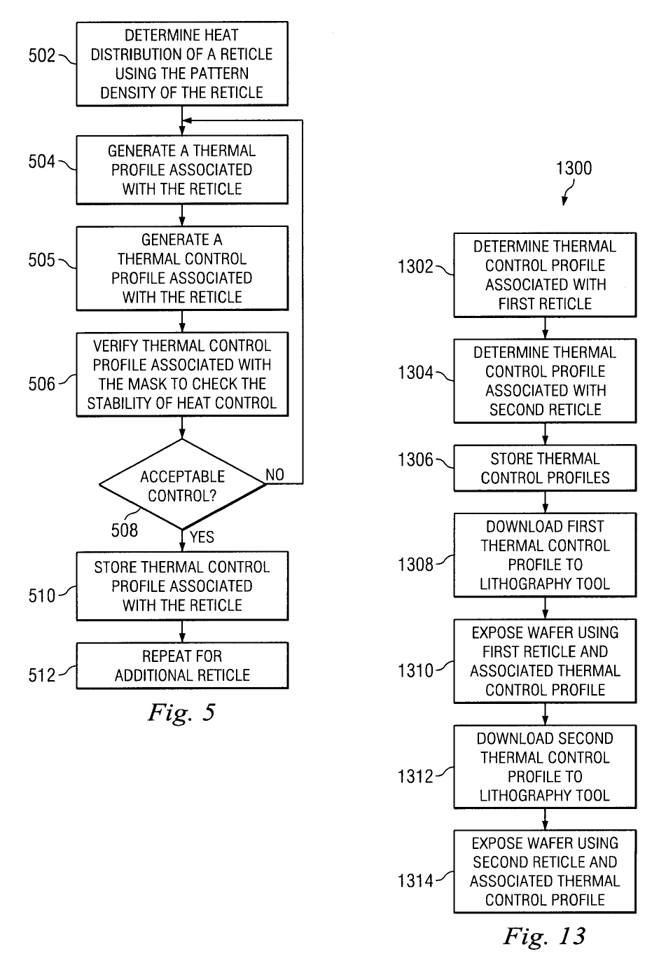

To dissipate the heat from the distorted reticle 406, heat is conducted out of the reticle 406 and into a thermal control chuck 408. The thermal control chuck 408 may be substantially similar to the chuck 304, described above with reference to FIG. 3b. The accumulated heat may then travel from the reticle 406 to the chuck 408 as illustrated by reference arrows 410. The thermal control chuck 408 uses a thermal profile and/or thermal control profile generated using the method described below with reference to FIG. 5 to determine a parameter (e.g., a temperature gradient across one or more zones of the chuck). The thermal control chuck may have multiple temperature zones (e.g. corresponding to thermal couples 316 and temperature sensor 318) that can provide thermal control according to the thermal control profile (e.g., provide an compensating temperature gradient across the chuck). This allows for heat accumulated in a zone to be effectively dissipated by that zone. Each zone may adjust the amount of heat that it dissipates. On dissipation of heat from the distorted reticle 406, the reticle is returned to an approximately ambient state as illustrated in reticle 412. Though illustrated as removing heat accumulated from the distorted reticle 406, the thermal control chuck 408 may remove heat generated by the incident EUV radiation 402 in a manner such that that distortion of the reticle does not occur. In an embodiment, the thermal control chuck 408 uses a thermal control profile to provide for effective heat dissipation across the reticle such that the reticle is an approximately equal temperature at points across the reticle.

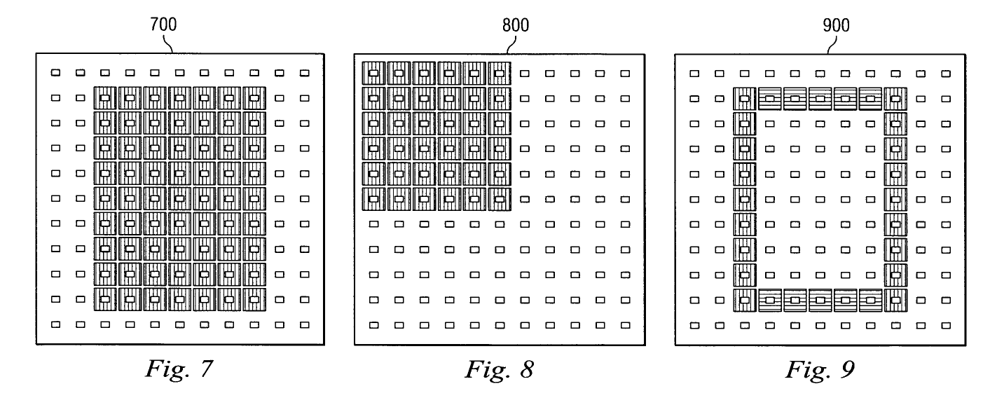

Referring now to FIG. 5, illustrated is a method of providing thermal control profiles associated with one or more reticles. The method 500 begins at step 502 where heat distribution of a reticle is determined using the pattern density of the reticle. The pattern density of a reticle may be determined by determining the distribution of features included in the pattern formed on the reticle, which may be imaged onto a wafer. Increased density of features may require a longer exposure time (e.g., greater amount incident EUV radiation), which may cause an increase in heat accumulation in the area of increased density, as compared to a less dense region. FIGS. 7, 8, and 9 illustrate representative embodiments of reticle pattern densities. FIG. 7 illustrates a reticle 700 including a greater pattern density in the center of the reticle. FIG. 8 illustrates a reticle 800 including a greater pattern density in the upper left of the reticle. FIG. 9 illustrates a reticle 900 including a ring area of greater pattern density. It should be noted that reticles 700, 800, and 900 are exemplary only and not intended to be limiting in any manner. The pattern density may be determined, for example, by inspection of a reticle or design data.

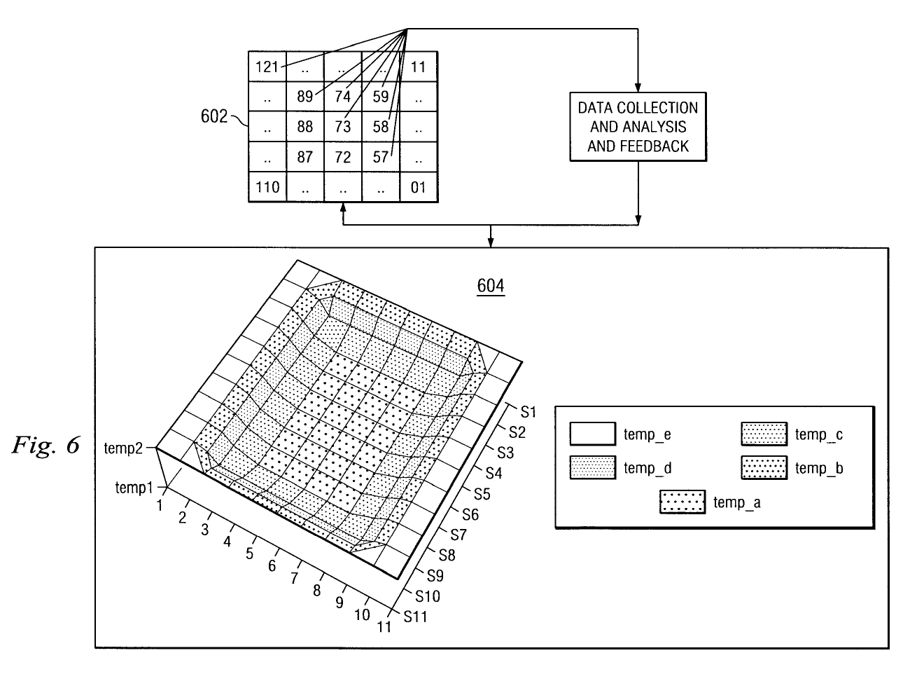

The method 500 then proceeds to step 504 where a thermal profile associated with the reticle is determined. The thermal profile may be generated using experimental data and/or models. The thermal profile may include a relative and/or absolute value of heat accumulation of a reticle. In an embodiment, in step 505 a thermal profile for a chuck, such as the chuck 304, described above with reference to FIG. 3b may also be provided in addition to or in lieu of the thermal profile of a reticle. In an embodiment, the layout of the chuck and/or reticle is divided into a plurality of regions (or zones), for example, an array of regions. For example, the device may be divided into 121 regions, 11 divisions made at each of two perpendicular sides of the device. FIG. 6 illustrates a division of a layout of a reticle into an array of segments (e.g., 121 segments) as illustrated by segmentized reticle layout 602. Data is collected from each segment. The data may include pattern density found within the segment and/or data on effect of surrounding segments. Such data is analyzed to determine a heat accumulation for the segment. The heat accumulation from a segment may be used (e.g., feedback) to determine the heat accumulation for other segments within the reticle. From this analysis, a thermal profile such thermal profile 604 is determined. In an embodiment, each of the regions (zones) corresponds to a thermal couple and temperature sensor provided on the thermal control such, such as, the thermal couple 316 and temperature sensor 318 described above with reference to FIG. 3b.

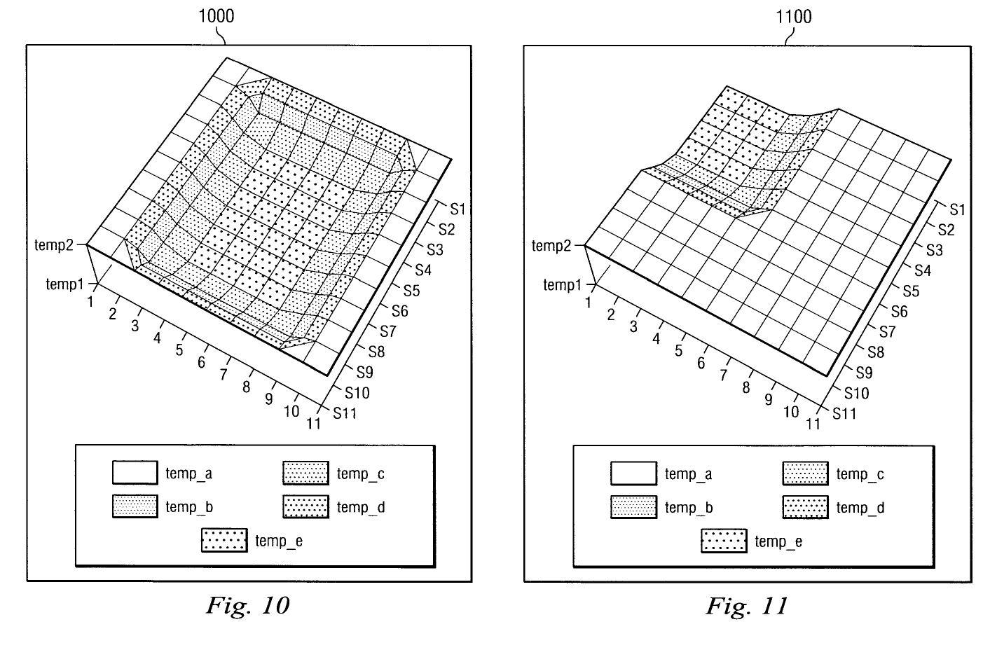

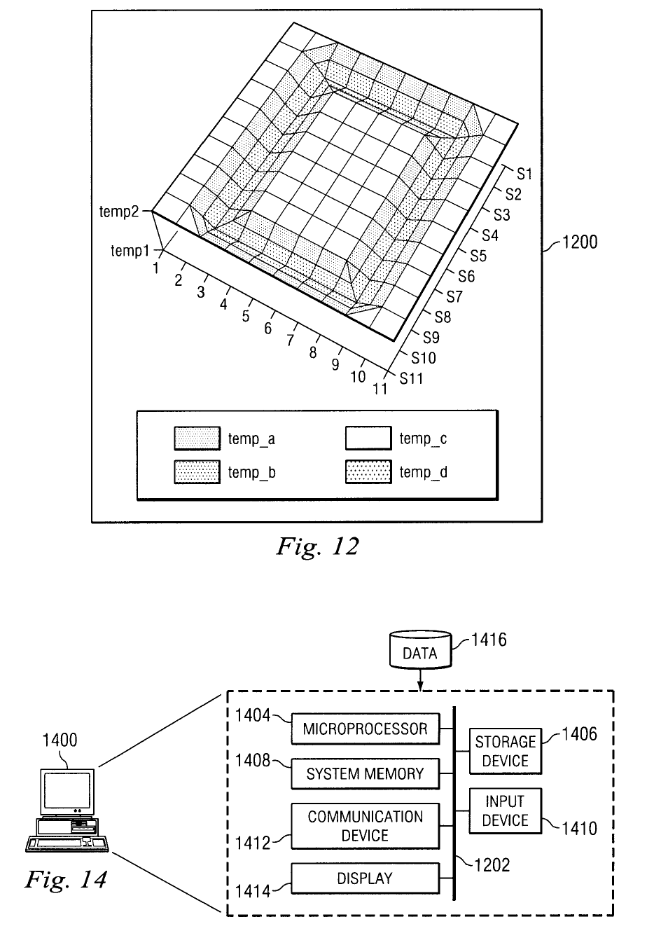

FIGS. 10, 11, and 12 illustrate thermal profiles 1000, 1100, and 1200, respectively, each associated with a corresponding the reticle 700, 800, and 900 respectively. The thermal profile 1000, corresponding to the reticle pattern of FIG. 7, illustrates a concentration of heat in the center of the profile. The thermal profile 1100 of FIG. 11, corresponding to the reticle pattern of FIG. 8, illustrates a concentration of heat in a corner of the profile. The thermal profile 1200 of FIG. 12, corresponding to the reticle pattern of FIG. 9, illustrates a concentration of heat in a ring within the profile. The thermal profiles 1000, 1100, and 1200 may be used to provide a thermal control profile to a thermal control chuck, which can be used to alter a heat dissipation capability of one or more zones of the thermal control chuck (e.g., change the temperature) such as to provide for an appropriate level of dissipation. One embodiment of a thermal control chuck operable to perform such dissipation is described above with reference to the thermal control chuck 304 of FIG. 3b.

The method 500 then proceeds to step 505, where the thermal profile generated in step 504 such as, the thermal profile 1000, 1100, and/or 1200, is used to develop thermal control (e.g., a thermal control profile) for a lithography system. In particular, the thermal profile, specific to one or more reticles, may be used to generate a thermal control profile specific to each of the reticle(s). The thermal control profile allows reticle heat to be dissipated during EUV lithography process. The thermal control profile includes any variety of thermal control methods that are determined using the thermal profile such as to provide for effective heat dissipation, for example, in areas of the reticle for which the thermal profile illustrates extensive heating. The thermal control profile may be implemented by a thermal control chuck, which has multiple zones or areas each operable to provide heat dissipation. The zones of the thermal control chuck may correspond to the areas or zones provided in a thermal profile, such as described above. The thermal control profile may provide a setting (e.g., temperature) for one or more of multiple zones provided by a thermal control chuck. In an embodiment, the thermal control profile determines a temperature gradient across the thermal control chuck. The thermal control profile may be implemented using a controller coupled to one or more thermal couples and/or temperature sensors of a thermal control chuck, for example, as described above with reference to FIG. 3b. The thermal control profile may include a “recipe” used to perform a lithography process. In addition to the parameters provided to the thermal control chuck, the “recipe” may include one or more additional equipment and/or process parameters to be used in the EUV system. For example, the thermal control profile may also include, exposure time, exposure speed, power, reticle positioning, substrate positioning, spot size, and/or other parameters of a lithography process. In an embodiment, if a thermal control profile can not be adequately provided by a thermal control chuck (e.g., adequate heat can not be dissipated), then other parameters may be varied such as, lowering an exposure dose and/or increasing exposure time. The thermal control profile may be determined using experimental results and/or models of behavior during lithography.

Thus, the thermal control profile is used by the thermal control chuck to provide selective heat dissipation. The heat dissipation required is determined from a thermal profile associated with a reticle held by the chuck. The thermal control profile may be used to determine a temperature gradient across the chuck that compensates for the high heat accumulation areas defined by the thermal profile.

The method 500 then proceeds to step 506 where the thermal profile and/or the thermal control profile associated with the mask is verified. The verification may include checking the stability of heat control provided using the thermal control profile. To check the stability of heat control one or more substrates may be exposed using the thermal control profile.

The method 500 then proceeds to decision block 508. At decision block 508 it is determined if the thermal control is acceptable. In an embodiment, it is determined the control is not effective including for example, the thermal control profile and/or thermal profile is not sufficiently effective or accurate. In the embodiment, the method 500 returns to step 504. Information may be feedback, profiles optimized (e.g., models used to generate the profile(s) optimized), and/or regenerated. In an embodiment, it is determined that the control is sufficient and the method 500 proceeds to step 510. The sufficiency of control may be determined, for example, by determining the heat accumulation of the reticle, the distortion of the reticle, the performance of the reticle (e.g., IPD, OPD, DOF), and/or other metrics. In an embodiment, if the thermal control is determined to be ineffective, additional parameters may be changed. For example, if the thermal control provided by a thermal control chuck using a thermal control profile is insufficient, additional EUV lithography parameters may be altered such as, exposure time or exposure power.

At step 510, the verified thermal control profile associated with the mask is stored. The profile may be stored such that can be provided to an EUV lithography system when performing a lithography process using the reticle with which the profile is associated. The method 500 then proceeds to step 512 where the method may be repeated for additional reticles including each including different patterns. A plurality of thermal control profiles each associated with one or more reticles may be stored. The thermal control profile may be stored by a computer system such as the computer system 1400, described below with reference to FIG. 14.

Referring to FIG. 13, illustrated is a flowchart of a method 1300 of performing an EUV lithography process. The method 1300 begins at step 1302 where a thermal control profile associated with a first reticle is determined. The method 1300 then proceeds to step 1304 where a thermal control profile associated with a second reticle is determined. The first and second reticle may be reticles associated with different layers of the same integrated circuit (IC) device, or with different IC devices. The thermal control profiles may be determined using the method 500 or portion thereof, described above with reference to FIG. 5. The thermal control profiles may be determined using the computer system 1400 described below with reference to FIG. 14. The thermal control profiles for each respective reticle are stored in step 1306 of the method 1300. Step 1306 may be substantially similar to the step 510 described above with reference to FIG. 5. The thermal control profiles may be stored by one or more components of the computer system 1400 such as the system memory 1408 or storage 1406 described below with reference to FIG. 14.

The method 1300 then proceeds to step 1308 where the first thermal control profile is sent (e.g., downloaded) to a lithography tool. The thermal control profile may include process and/or equipment parameters (e.g., recipe) for use in the lithography tool. The lithography tool may be an EUV lithography tool substantially similar to as described above with reference to FIG. 1. In an embodiment, the thermal control profile includes at least one parameter for a thermal control reticle chuck included in the EUV lithography tool. The method 1300 then proceeds to step 1310 where the first reticle and the thermal control profile associated with the first reticle are used to pattern a substrate. The substrate may be substantially similar to the substrate 110 described above and include a layer of photoresist. In an embodiment, the exposure process of 1310 includes exposing a substrate using a temperature gradient of a thermal control chuck which is determined from the thermal control profile.

The method 1300 then proceeds to step 1312 where the second thermal control profile is downloaded to the lithography tool. The second thermal control profile, associated with a second reticle, may include process and/or equipment parameters that differ from the first thermal control profile. Thus, the second thermal control profile may provide for a different heat dissipation from a reticle than the first thermal control profile. In an embodiment, the thermal control profile includes at least one parameter for a thermal control reticle chuck included in the EUV lithography tool. The method 1300 then proceeds to step 1314 where a substrate is exposed using the second reticle and its associated thermal control profile (second thermal control profile). The substrate may be the same, or different, than that exposed in step 1310. The substrate may be substantially similar to the substrate 110 described above and include a layer of photoresist. The pattern exposed by the second reticle may be different than that of the first reticle. In an embodiment, the exposure process of 1314 includes exposing a substrate using a temperature gradient of a thermal control chuck which is determined from the thermal control profile. The temperature gradient may be different than that provided above in an embodiment of step 1310. The substrates may continue to be processed as known in the art, including photolithography processes such as baking, development of the exposed photoresist, and/or other processes known in the art.

Referring now to FIG. 14, illustrated is an embodiment of a computer system 1400 for implementing embodiments of the present disclosure including the systems and methods described herein. In an embodiment, the computer system 1400 includes functionality providing for determining a thermal profile, thermal control profile, and/or implementing thermal control profile, as described above.

The computer system 1400 includes a microprocessor 1404, an input device 1410, a storage device 1406, a system memory 1408, a display 1414, and a communication device 1412 all interconnected by one or more buses 1402. The storage device 1406 may be a floppy drive, hard drive, CD-ROM, optical device or any other storage device. In addition, the storage device 1406 may be capable of receiving a floppy disk, CD-ROM, DVD-ROM, or any other form of computer-readable medium that may contain computer-executable instructions. The communications device 1412 may be a modem, a network card, or any other device to enable the computer system to communicate with other nodes. It is understood that any computer system 1400 could represent a plurality of interconnected computer systems such as, personal computers, mainframes, PDAs, and telephonic devices. The communications device 1412 may allow communications between the computer system 1400 and one or more tools/computer systems used in the fabrication of an IC, for example, an EUV lithography tool such as the system 100 described above with reference to FIG. 1.

The computer system 1400 includes hardware capable of executing machine-readable instructions as well as the software for executing acts (typically machine-readable instructions) that produce a desired result. Software includes any machine code stored in any memory medium, such as RAM or ROM, and machine code stored on other storage devices (such as floppy disks, flash memory, or a CD ROM, for example). Software may include source or object code, for example. In additional software encompasses any set of instructions capable of being executed in a client machine or server. Any combination of hardware and software may comprise a computer system. The system memory 1408 may be configured to store a pattern, such as formed on a reticle, a thermal profile, and/or a thermal control profile.

Computer readable mediums include passive data storage, such as RAM as well as semi-permanent data storage such as a compact disk read only memory (CD-ROM). In an embodiment of the present disclosure may be embodied in the RAM of a computer to transform a standard computer into a new specific computing machine. Data structures are defined organizations of data that may enable an embodiment of the present disclosure. For example, a data structure may provide an organization of data, or an organization of executable code. Data signals could be carried across transmission mediums and store and transport various data structures, and thus, may be used to transport an embodiment of the present disclosure. The microprocessor 1404 may perform the mathematical functions necessary to perform the thermal profile and thermal control profile generation and/or implementation of control of a photolithography process and/or equipment using a thermal control profile.

A database 1416 may be any standard or proprietary database software known in the art. The physical location of the database 1416 is not limiting and may exist remotely from the server, be accessible by internet or intranet. The disclosure of the database 1416 includes embodiments that include a plurality of databases. The database 1416 may include manufacturing data, IC patterns (e.g., physical layout of a layer of an IC), model parameters, and/or other data useful in the fabrication of IC using the methods and apparatus described herein.

Although only a few exemplary embodiments of this invention have been described in detail above, those skilled in the art will readily appreciate that many modifications are possible in the exemplary embodiments without material departing from the novel teachings and advantages of this disclosure.

Thus, provided is a method of patterning an integrated circuit. A thermal profile of a reticle is generated, including determining a pattern density included on the reticle. The reticle is radiated with a beam having an EUV wavelength. The radiation of the reticle includes controlling heat dissipation from the radiated reticle using the generated thermal profile.

Also provided is a system including a computer system, a reticle, and an extreme ultraviolet (EUV) lithography apparatus. The computer system generates thermal control profiles (e.g., a profile for each of multiple reticles). The reticle included in the system may be associated with a thermal control profile. The EUV lithography apparatus is operably coupled to the computer system such that the computer system can provide the thermal control profile to the EUV lithography apparatus.

Further provided is a computer readable medium comprising computer readable instructions providing instructions to generate a first thermal profile of a first extreme ultraviolet (EUV) lithography reticle and a second thermal profile of a second EUV lithography reticle. The instructions may also provide for generating a first thermal control profile associated with the first reticle using the first thermal profile. The first thermal control profile includes a setting for at least one parameter to be used in an EUV lithography process using the first reticle. The instructions further provide for generating a second thermal control profile associated with the second reticle using the second thermal profile. The second thermal control profile includes a setting for at least one parameter to be used in an EUV lithography process using the second reticle. The settings for a parameter may be different between the first and second thermal control profiles. These differences may provide for different heat dissipation from the reticle. The instructions may provide for storing the first thermal control profile and the second thermal control profile.

What is claimed is:

1. A method of patterning an integrated circuit, comprising:
generating a thermal profile of a reticle, wherein the generating the thermal profile includes determining a pattern density of the reticle; and
radiating the reticle with a radiation beam having an extreme ultraviolet (EUV) wavelength, wherein the radiating includes controlling heat dissipation from the radiated reticle using the generated thermal profile.

2. The method of claim 1, wherein the radiation beam has a wavelength of approximately 13.5 nm.

3. The method of claim 1, wherein the reticle includes a patterned absorption layer and a reflective film, wherein the reflective film includes a plurality of layers.

4. The method of claim 1, further comprising:
generating a second thermal profile of a second reticle, wherein the generating the second thermal profile includes determining a pattern density of the second reticle; and
radiating the second reticle with a second radiation beam, wherein the radiating includes controlling heat dissipation from the radiated second reticle using the generated second thermal profile.

5. The method of claim 1, wherein the controlling the heat dissipation includes dissipating heat from the reticle using a thermal control chuck, wherein a temperature gradient of the thermal control chuck is defined using the thermal profile.

6. The method of claim 1, further comprising:
determining the heat dissipation required by each of a plurality of zones of a thermal control chuck using the thermal profile of the reticle.

7. The method of claim 1, further comprising:
generating a thermal control profile associated with the reticle using the thermal profile; and wherein the radiating the reticle including using at least one parameter defined by the thermal control profile.

8. The method of claim 7, wherein the radiating the reticle includes downloading the thermal control profile to an EUV system including an EUV exposure tool.

9. The method of claim 1, wherein the thermal profile defines an area of heat accumulation on the reticle, and wherein the area corresponds to a reticle region including increased pattern density.

10. The method of claim 1, further comprising:
verifying the thermal control profile; and
storing the thermal control profile.

11. The method of claim 1, further comprising:
exposing a region of a substrate using a reflected radiation beam, wherein the radiating the reticle includes providing a reflected radiation beam, and wherein the reflected radiation beam includes a pattern.

12. The method of claim 1, wherein the generating a thermal profile includes dividing the reticle into a plurality of regions and determining a heat accumulation value for each of the plurality of regions.

13. A system, comprising:
a computer system for generating a thermal control profile;
a reticle associated with the thermal control profile; and
a extreme ultraviolet (EUV) lithography apparatus coupled to the computer system, wherein the computer system is operable to provide the thermal control profile to the EUV lithography apparatus.

14. The system of claim 13, wherein the thermal control profile includes a temperature setting for at least one zone of a thermal control chuck.

15. The system of claim 13, wherein the thermal control profile is generated using a pattern density of the reticle.

16. The system of claim 13, wherein the lithography apparatus includes a reticle housing including a thermal control chuck.

17. The system of claim 13, wherein the computer system stores a plurality of thermal control profiles each associated with a different reticle.

18. A computer readable medium comprising computer readable instructions providing instructions to:
generate a first thermal profile of a first extreme ultraviolet (EUV) lithography reticle and a second thermal profile of a second EUV lithography reticle;
generate a first thermal control profile associated with the first reticle using the first thermal profile, wherein the first thermal control profile includes a first setting for at least one parameter to be used in an EUV lithography process using the first reticle;
generate a second thermal control profile associated with the second reticle using the second thermal profile, wherein the second thermal control profile includes a second setting for at least one parameter to be used in an EUV lithography process using the second reticle; and
storing the first thermal control profile and the second thermal control profile.

19. The computer readable medium of claim 18, further comprising instructions to:
communicate the first thermal control profile to a lithography tool, wherein the lithography tool includes a thermal control chuck.

20. The computer readable medium of claim 18, wherein the generating a first thermal profile includes subdividing a layout of the first reticle into a plurality of regions and determining the heat accumulation for each of the plurality of regions.
